(19) United States
(12) Patent Application Publication
(10) Pub. No.: US 2002/0158467 A1
(43) Pub. Date: Oct. 31, 2002

(54) Quick connect / disconnect device and brake-fluid supply system fitted with such device

(76) Inventors: Demersseman Remi, rue St Martin (FR); Come Philippe, Senlis (FR)

Correspondence Address: Leo H McCormick Jr, 2112 Mishawaka Avenue, PO Box 4721 2800 South 25th Avenue, South Bend, IN, 46634-4721, US

(21) Appl. No.: 09/869,791

(22) PCT Filed: Jun. 5, 2001
(86) PCT No.: PCT/FR01/01734

(30) Foreign Application Priority Data
Jun. 9, 2000 (FR) FR00/08616

(51) Int. Cl. F16L 39/00

(52) U.S. Cl. 285/124.1

(57) ABSTRACT

This invention mainly relates to a quick connect/disconnect device for flexible tubular pipes and to a brake-fluid supply system including such a device, in particular for the interconnection of a plurality of brake-fluid tanks, by means of at least one flexible tubular pipe.

The connect/disconnect device for flexible tubular pipes to/from a brake-fluid tank comprises a first receiving cavity for a ring (15) intended for the axial retaining of said flexible tubular pipe, and a second accommodating and guiding cavity (33) for a disconnecting tool (23), perpendicularly to the axis of the flexible tubular pipe to be disconnected, said disconnecting tool (23) having axial ramps (25) capable of cooperating with said ring (15) and of moving it axially so as to release the flexible tubular pipe.

The present invention concerns, more particularly, the motor car industry.

And the present invention mainly applies to the design and manufacturing of motor vehicle braking systems.

This invention mainly relates to a quick connect/disconnect device for flexible tubular pipes and to a brake-fluid supply system including such a device, in particular for the interconnection of a plurality of brake-fluid tanks, by means of at least one flexible tubular pipe.

The Patent Application EP 98 944 011.0, incorporated herein by way of reference, describes a safety supply device for a dual hydraulic braking circuitry comprising a first high-capacity top tank, which is connected by means of a single flexible tubular pipe to a second lower-capacity bottom tank. The second lower-capacity bottom tank alone is fitted with a partition wall defining two separate brake-fluid chambers.

EP 98 944 011.0 neither describes nor even suggests the implementation of either quick connectors or of quick disconnect devices for flexible tubular pipes interconnecting the first and second tanks. Thus, on the one hand, the connecting and disconnecting operations take a long time and, on the other hand, one cannot make sure that a correct interlocking connection has actually been achieved.

Therefore, it is an object of the present invention to provide a brake-fluid supply system, allowing fast assembling and disassembling operations.

Another object of this invention consists in providing a brake-fluid supply system having a high reliability.

These objects are achieved, in accordance with this invention, by a quick connect/disconnect device and by a disconnecting tool for tubular flexible pipes, to/from a brake-fluid tank for motor vehicles.

The main subject of this invention is a connect/disconnect device for flexible tubular pipes to/from a brake-fluid tank, comprising a first receiving cavity for a ring intended for the axial retaining of said flexible tubular pipe, and a second accommodating and guiding cavity for a disconnecting tool, perpendicularly to the axis of the flexible tubular pipe to be disconnected, said disconnecting tool having axial ramps capable of cooperating with said ring and of moving it axially so as to release the flexible tubular pipe.

The present invention also deals with a device, characterised in that the ramps of the disconnecting tool are capable of pushing axially said ring intended for the retaining of the flexible tubular pipe, so as to release said flexible tubular pipe.

Another subject matter still of the present invention is a device, characterised in that the disconnecting tool further comprises cheeks carrying said ramps, wherein said cheeks have, contrarily to the ramps, a constant thickness in the axial direction.

According to another aspect of the invention, the device is characterised in that the disconnecting tool exhibits a symmetrical shape so as to be reversible.

The present invention also deals with a device, characterised in that said device permits the simultaneous connection of at least two flexible tubular pipes having parallel or substantially parallel axes.

Another subject matter still of the present invention is a device, characterised in that it comprises a disconnecting tool, including ramps for the simultaneous disconnection of at least two flexible tubular pipes.

According to another aspect of the invention, said device is characterised in that the disconnecting tool has a U-shaped slot, which is edged with said axial ramps.

Another subject of the invention is a brake-fluid tank, characterised in that it comprises a connect/disconnect device.

This invention also deals with a brake-fluid supply system, characterised in that it comprises at least two brake-fluid tanks, interconnected by at least one flexible tubular pipe connected at least at one end by said device.

Another subject matter still of the present invention is a system, characterised in that said two tanks are interconnected by at least two flexible tubular pipes.

In an advantageous manner, the brake-fluid supply system according to this invention comprises a first top tank connected to a second bottom brake-fluid tank by means of a flexible tubular pipe, the connection of which is carried out using a quick connector.

In the preferred embodiment according to the present invention, the brake-fluid supply device comprises a first top tank having two separate brake-fluid chambers, a second bottom tank having two separate brake-fluid chambers, as well as two tubular pipes, a first flexible tubular pipe connecting a first top-tank chamber to a first bottom-tank chamber, whereas the second flexible tubular pipe connects the second top-tank chamber, the holding capacity of which is different from that of said first top-tank chamber, to a second bottom-tank chamber, the holding capacity of which is also different from that of said first bottom-tank chamber.

In an advantageous manner, the second bottom tank is directly made integral with a tandem master cylinder, whereas the top tank is arranged in a place readily visible and/or accessible by the user of the motor vehicle.

Advantageously too, the first and second chambers of the top tank are tight each with respect to the other but connected to the atmosphere by means of a vent pipe.

On the other hand, the first and second chambers of the bottom tank are hermetically separated both mutually and with respect to the atmosphere.

The maintenance operations to be carried out on the motor vehicle may require a disconnection of the flexible tubular pipes. According to the illustrated preferred embodiment of this invention, a connect/disconnect device 1 comprises means capable of cooperating with a quick-disconnecting tool 23 for a flexible tubular pipe. The disconnecting tool 23, as shown in FIGS. 5 through 9, exhibits, e.g., ramps 25 running along each one of two U-shaped slots 27 for the simultaneous applying of the tool 23 to both flexible tubular pipes to be disconnected. In the illustrated advantageous example, the ramps 25 are bordered, on the outer edges of the tool 23, by cheeks 29, the thickness of which corresponds to the substantially constant thickness of the tool. On the opposite side with respect to the slots 27, the tool 23 is provided with an advantageously striated gripping area 31.

Other features and advantages of the present invention will be apparent from the following detailed description, by way of example and by no means as a limitation, when taken in conjunction with the accompanying drawings, in which:

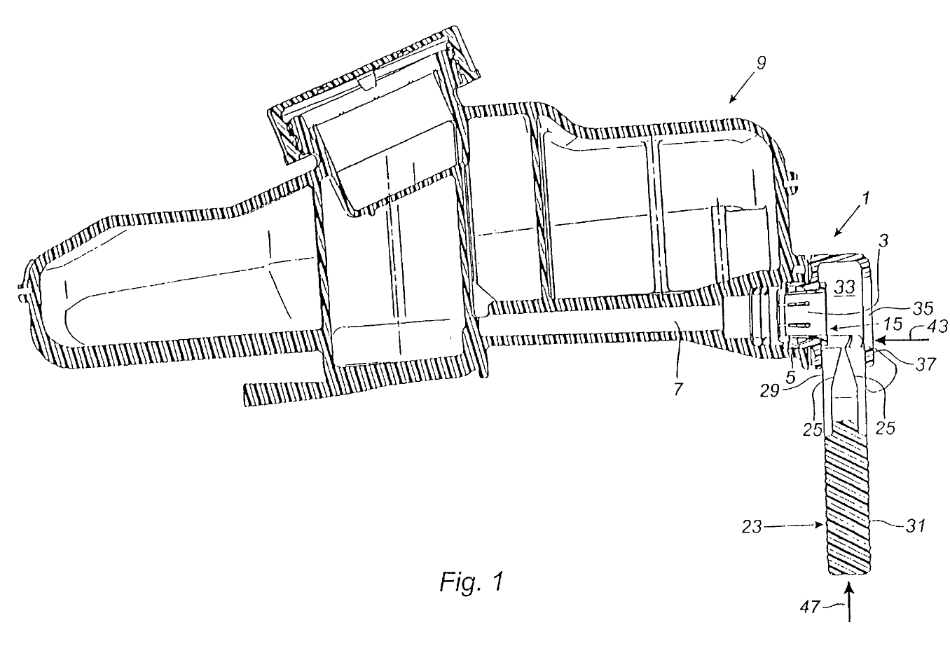

FIG. 1 is a longitudinal sectional view of the preferred embodiment of a tank and of a tool intended for the disconnection of flexible tubular pipes from a support for a quick connector cooperating with the tank;

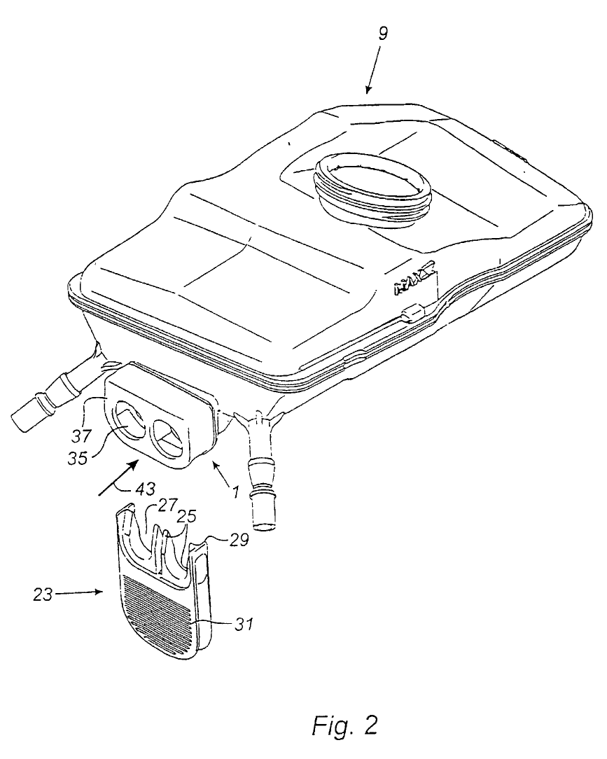

FIG. 2 is a three-quarter perspective view of the preferred embodiment of a tank comprising a support for a quick connector, and of a tool intended for the disconnection of flexible tubular pipes from a support for a quick connector according to the present invention;

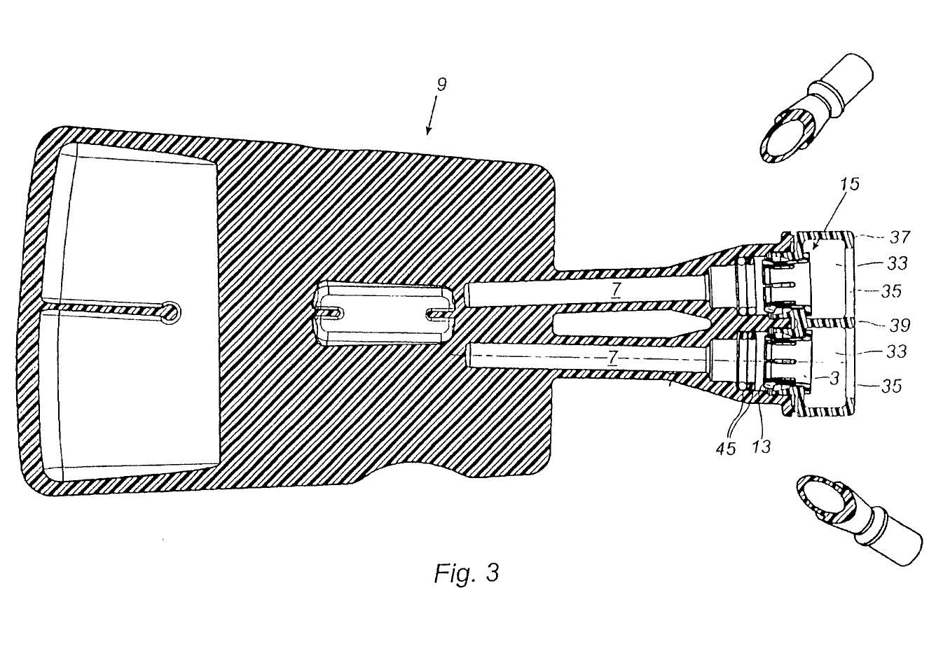

FIG. 3 is a longitudinal sectional view in a plane perpendicular to the sectional plane of FIG. 1;

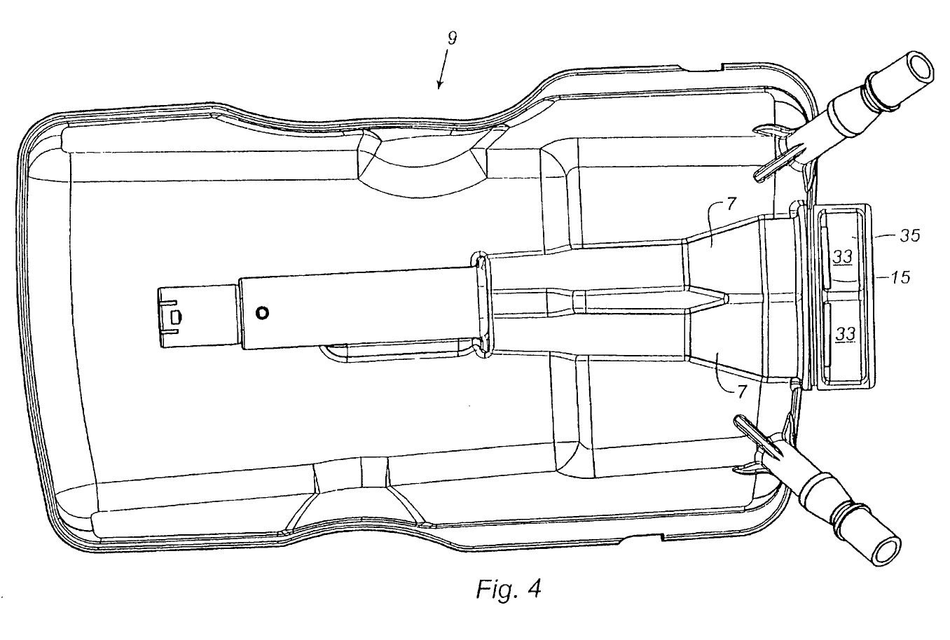

FIG. 4 is a bottom view of a tank comprising a support for a quick connector;

FIG. 5 is a three-quarter perspective view of the preferred embodiment of a tool intended for the disconnection of flexible tubular pipes from a support for a quick connector according to the present invention;

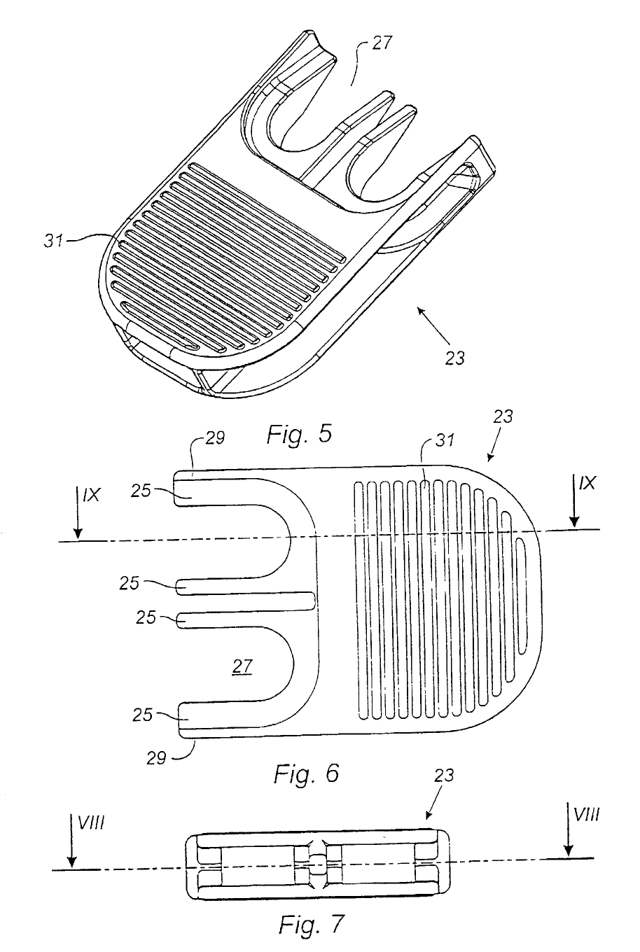

FIG. 6 is a plan view of the preferred embodiment of a tool intended for the disconnection of flexible tubular pipes from a support for a quick connector according to the present invention;

FIG. 7 is a side view of the preferred embodiment of a tool intended for the disconnection of flexible tubular pipes from a support for a quick connector according to the present invention;

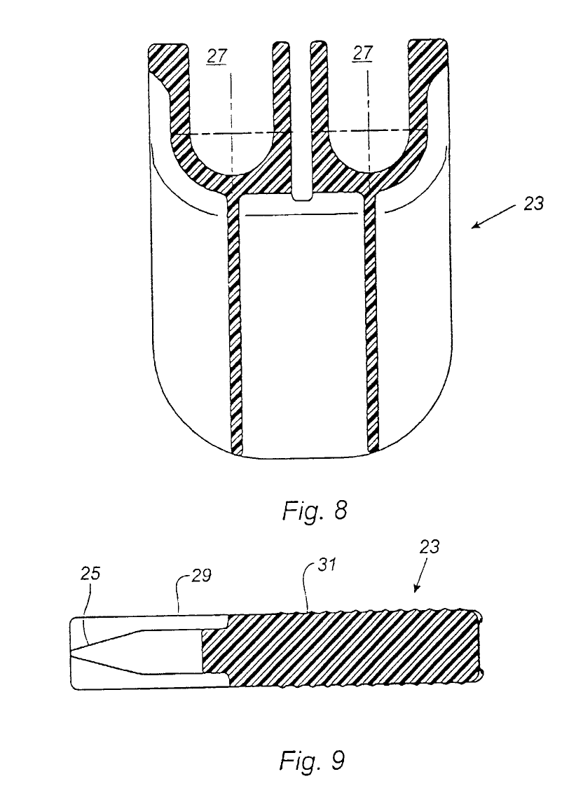

FIG. 8 is a longitudinal sectional view along line VIII-VIII of FIG. 7; and

FIG. 9 is a cross-sectional view along line IX-IX of FIG. 6.

In the non-limitative illustrated embodiment, the disconnecting tool 23 is symmetrical about a median line, for its fitting indifferently in both directions. Yet it should be understood that a tool, which would be non-symmetrical about its main median line, does not depart from the scope of this invention. In the same way, in the advantageous embodiment as shown, the quick disconnecting tool 23 makes it possible to disconnect both flexible tubular pipes simultaneously. However, the implementation of simple tools for the disconnection of one pipe only does not depart from the scope of the invention. With such a tool, a single pipe can be disconnected at once or several pipes may be disconnected one after another, which requires several successive operations.

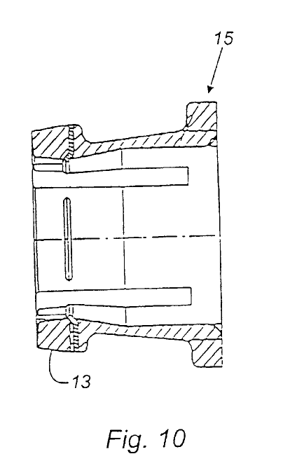

FIGS. 1 through 4 show the preferred embodiment of a brake-fluid tank 9, fitted with an interconnection device according to the present invention, implementing quick connectors, e.g. connectors having a claw ring, preferably like that marketed by the John GUEST Company and as illustrated in FIG. 10. The interconnection device comprises at least one, and preferably two through-holes 3 for the passage of flexible tubular pipes (not shown).

In an advantageous manner, a through-hole 3 is defined by a sleeve 5, the radially-inner diameter of which is smaller than the radially-outer diameter of an outlet pipe of the tank 9, in such a way that the end part of the sleeve 5 forms a shoulder for the axial retaining of a radial protrusion 13 (FIG. 10) of the claw ring 15, shown in FIG. 10.

It should be noted that said shoulder, resulting from a change in the inner diameter, requires the use of a connector support added to the tank 9 since a tank made in one block would mean a hardly strippable casting, not to say unremovable from the mould.

Thus, the connection device according to this invention comprises a cavity 33 intended for the accommodating and guiding of the disconnecting tool 23, perpendicularly to the axis of the flexible tubular pipe to be disconnected.

In the preferred embodiment as illustrated, the accommodating cavity 33 has a substantially rectangular shape with rounded-off angles at the lower part, near the opening for the insertion of the tool 23. Through-holes 35 for the passage of the flexible tubular pipe(s) are arranged opposite the through-holes 3 and they are provided in the front face 37, substantially parallel to the rear face of the device 1 according to this invention. A stiffening rib 39 advantageously links the rear wall with the front wall 37, between the through-holes 3 and 35, corresponding to both of the flexible tubular pipes.

In the motor-vehicle assembly line, the tank 9 is fastened to its support and one end of each flexible tubular pipe is engaged in the through-holes 35 and 3 in the direction of the arrow 43, so as to be slipped into the sleeve 5 and to be retained by the claw ring 15 in a position in which at least one of the seals 45 makes for a tight connection. The flexible tubular pipes may be connected to the pipe 7 of the tank 9 either by hand or, as a variant, using a robot.

If, for instance for a maintenance operation, the flexible tubular pipe(s) must be disconnected, advantageously after having removed the brake fluid from the tank 9, the disconnecting tool 23 is inserted in the direction of the arrow 47. The cheeks 29 are guided by the inner walls of the accommodating cavity 33 and the ramps 25 push back the claw ring 15 in the direction of the arrow 43, as a consequence of which the flexible tubular pipes are released.

In an advantageous manner, the tank 9 consists of a rigid plastic, such as polypropylene, compatible with the brake fluid.

The present invention concerns, more particularly, the motor car industry.

And the present invention mainly applies to the design and manufacturing of motor vehicle braking systems.

1. Connect/disconnect device for flexible tubular pipes to/from a brake-fluid tank, comprising a first receiving cavity for a ring (15) intended for the axial retaining of said flexible tubular pipe, and a second accommodating and guiding cavity (33) for a disconnecting tool (23), perpendicularly to the axis of the flexible tubular pipe to be disconnected, said disconnecting tool (23) having axial ramps (25) capable of cooperating with said ring (15) and of moving it axially so as to release the flexible tubular pipe.

2. Device according to claim 1, characterised in that the ramps (25) of the disconnecting tool (23) are capable of pushing axially said ring (15) intended for the retaining of the flexible tubular pipe, so as to release said flexible tubular pipe.

3. Device according to claim 1 or 2, characterised in that the disconnecting tool (23) further comprises cheeks (29) carrying said ramps (25), wherein said cheeks (29) have, contrarily to the ramps (25), a constant thickness in the axial direction.

4. Device according to any one of the preceding claims, characterised in that the disconnecting tool (23) exhibits a symmetrical shape so as to be reversible.

5. Device according to any one of the preceding claims, characterised in that said device permits the simultaneous connection of a least two flexible tubular pipes having parallel or substantially parallel axes.

6. Device according to claim 5, characterised in that it comprises a disconnecting tool (23), including ramps for the simultaneous disconnection of at least two flexible tubular pipes.

7. Device according to any one of the preceding claims, characterised in that the disconnecting tool (23) has a U-shaped slot, which is edged with said axial ramps (25).

8. Brake-fluid tank, characterised in that it comprises a connect/disconnect device according to any one of the preceding claims.

9. Brake-fluid supply system, characterised in that it comprises at least two brake-fluid tanks, interconnected by at least one flexible tubular pipe connected at least at one end by means of a device according to any one of claims 1 through 7.

10. System according to claim 9, characterised in that said two tanks are interconnected by at least two flexible tubular pipes.
